(19) United States
(12) Patent Application Publication
(10) Pub. No.: US 2013/0250574 A1
(43) Pub. Date: Sep. 26, 2013

(54) LIGHTING UNIT AND LIGHTING DEVICE

(71) Applicants: Takayoshi MORIYAMA, Kanagawa (JP); Junya MURATA, Kanagawa (JP); Makoto YAMAZAKI, Kanagawa (JP); Yumi HANYUDA, Kanagawa (JP); Katsumi HISANO, Chiba (JP); Mitsuaki KATO, Kanagawa (JP); Masataka SHIRATSUCHI, Kanagawa (JP); Yuichiro YAMAMOTO, Kanagawa (JP)

(72) Inventors: Takayoshi MORIYAMA, Kanagawa (JP); Junya MURATA, Kanagawa (JP); Makoto YAMAZAKI, Kanagawa (JP); Yumi HANYUDA, Kanagawa (JP); Katsumi HISANO, Chiba (JP); Mitsuaki KATO, Kanagawa (JP); Masataka SHIRATSUCHI, Kanagawa (JP); Yuichiro YAMAMOTO, Kanagawa (JP)

(73) Assignees: Kabushiki Kaisha Toshiba, Tokyo (JP); Toshiba Lighting & Technology Corporation, Kanagawa (JP)

(21) Appl. No.: 13/567,891

(22) Filed: Aug. 6, 2012

(30) Foreign Application Priority Data
Mar. 26, 2012 (JP) 2012-070006

(51) Int. Cl. F21V 29/00; F21V 17/08; F21V 5/04

(52) U.S. Cl. 362/237; 362/235; 362/294; 362/311.01; 29/428

(57) ABSTRACT

A lighting unit according to one embodiment includes a board, an insulating plate, an optical lens, and a positioning member. The board has a mounting surface on which a light emitting element is mounted. The insulating plate is disposed on the mounting surface of the board to control the reflection direction of light emitted from the light emitting element. The optical lens diverges or converges the light reflected by the insulating plate. The positioning member positions the insulating plate and the optical lens such that the insulating plate and the optical lens are located away from each other by a predetermined distance. A lighting device according to one embodiment includes a plurality of the lighting units fixed to the lighting device via a fixing frame.

### CROSS-REFERENCE TO RELATED APPLICATION

This application is based upon and claims priority from prior Japanese Patent Application No. 2012-070006, filed on Mar. 26, 2012, the entire contents of which are incorporated herein by reference.

### FIELD

Embodiments described herein relate generally to a lighting unit and a lighting device.

### BACKGROUND

Currently, a lighting device which includes a light source provided with semiconductor light emitting elements such as LEDs (light emitting diodes) come in practical use. A type of this lighting device has a reflector which controls distribution of light emitted from the light source, an optical lens which diverges or converges the light received from the reflector after control of the distribution thereat, and heat radiation fins which stand on the outer wall of the reflector to dissipate heat generated from the light source to the outside, for example. According to this type of lighting equipment, however, the heat generated from the light emitting elements still has an influence on the optical lens in some cases even under dissipation of the heat from the heat radiation fins.

An object to be achieved by the embodiments is to provide a lighting unit and a lighting device capable of reducing the influence of heat imposed on an optical lens.

### DESCRIPTION OF THE DRAWINGS

FIG. 1 is a perspective view illustrating an example of the external appearance of a lighting device according to a first embodiment.

FIG. 2 is a perspective view illustrating the example of the external appearance of the lighting device.

FIG. 3 is a perspective view illustrating a disassembled condition of a lighting unit according to the first embodiment.

FIG. 4 is a perspective view illustrating a disassembled condition of the lighting unit.

FIG. 5 is a perspective view illustrating a disassembled condition of the lighting unit.

FIG. 6 is a perspective view illustrating an example of a disassembled condition of the lighting device.

FIG. 7 is a top view of the lighting device.

FIG. 8 is a cross-sectional view taken along a line I-I in FIG. 1.

FIG. 9 schematically illustrates an enlarged cross section of an optical lens according to the first embodiment.

FIG. 10 illustrates an example of the external appearance of an enlarged cross section of the optical lens.

FIG. 11 schematically illustrates an enlarged cross section of heat radiation fins according to a second embodiment.

FIG. 12 schematically illustrates an enlarged cross section of the heat radiation fins.

FIG. 13 illustrates arrangement patterns of an optical lens according to the second embodiment.

FIG. 14 illustrates bar-shaped components according to the second embodiment.

FIG. 15 illustrates bar-shaped components according to the second embodiment.

### DETAILED DESCRIPTION

Each of lighting units 100, 200, 300, and 400 according to exemplary embodiments to be discussed herein includes a board 120 which includes a mounting surface 120a on which light emitting elements 122 are mounted, an insulating plate (a reflector) 140 disposed on the mounting surface 120a of the board 120 and having holes 142 through which light emitted from the light emitting elements 122 are passed, an optical lens 160 for directing the light that is passed through the holes 142 of the insulating plate 140, and positioning members (spacers 150a through 150d) disposed in the lighting unit to separate the insulating plate from the optical lens 160 by a predetermined distance.

The positioning members of each of the lighting units 100, 200, 300, and 400 in the embodiments are disposed between the insulating plate 140 and the optical lens 160.

The insulating plate 140 of each of the lighting units 100, 200, 300, and 400 in the embodiments is formed integrally with the positioning members.

The insulating plate 140 of each of the lighting units 100, 200, 300, and 400 in the embodiments has a hole on a surface facing the optical lens 160 into which the positioning member is inserted.

The optical lens 160 of each of the lighting units 100, 200, 300, and 400 in the embodiments has a planar surface facing the insulating plate 140 that is substantially parallel to a surface of the insulating plate 140 facing the optical lens 160.

Each of the lighting units 100, 200, 300, and 400 in the embodiments further includes a support member (fin base 111) having an interior surface (a first surface) 111a on which the board 120 is disposed such that the interior surface 111a and the board are in close contact, and a plurality of heat radiation fins 112 disposed on an exterior surface (a second surface) 111b of the support member that is on an opposite side of the interior surface 111a. In this case, one end of each of the heat radiation fins 112 is embedded in the exterior surface 111b.

The heat radiation fins 112 of each of the lighting units 100, 200, 300, and 400 in the embodiments have elongated flat sides that are substantially parallel to each other and are physically separated from each other.

A lighting device 1 in the embodiments includes the lighting units 100, 200, 300, and 400, and fixing frames 10 and 20 for fixing the plural lighting units 100, 200, 300, and 400 such that the heat radiation fins of the plural lighting units 100, 200, 300, and 400 do not contact each other.

The lighting unit and the lighting device in the embodiments are hereinafter described with reference to the accompanying drawings. Similar parts in the respective embodiments are given similar reference numbers, and the same explanation is not repeated.

### First Embodiment

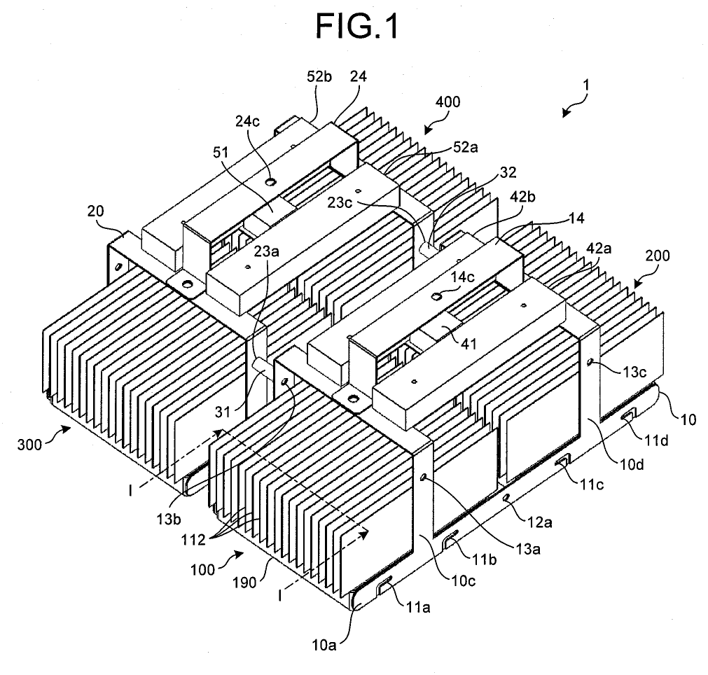

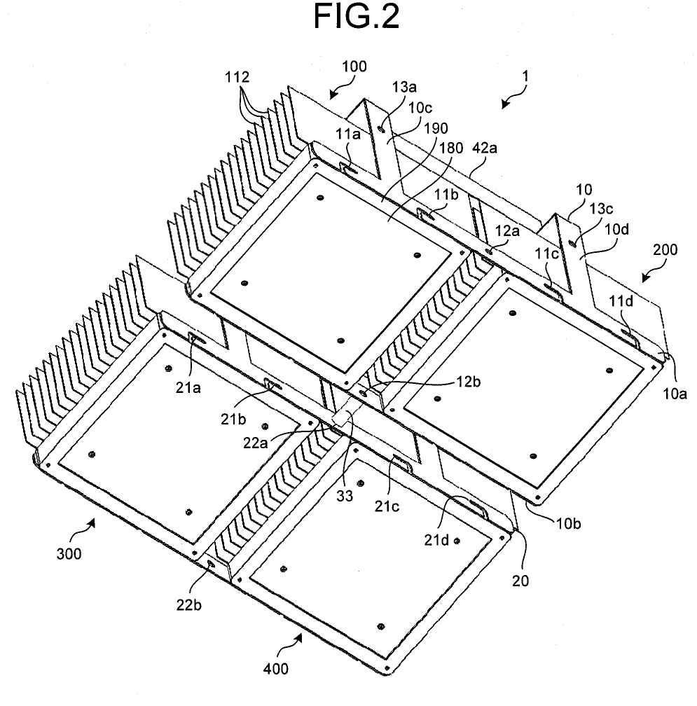

FIGS. 1 and 2 are perspective views illustrating an example of the external appearance of the lighting device 1 according to a first embodiment. FIG. 1 shows the lighting device 1 as diagonally viewed from above, while FIG. 2 shows the lighting device 1 as diagonally viewed from below.

The lighting device 1 illustrated in FIGS. 1 and 2 is a device attached to a high ceiling of a building such as a gymnasium to illuminate a wide space below the lighting device 1 in FIGS. 1 and 2 through emission of light from light emitting elements such as LEDs mounted within the lighting device 1.

According to the example shown in FIGS. 1 and 2, the lighting device 1 includes the four lighting units 100, 200, 300, and 400. More specifically, the lighting units 100 and 200 are fixed to the fixing frame 10, while the lighting units 300 and 400 are fixed to the fixing frame 20. The fixing frames 10 and 20 are joined to each other to be assembled into the lighting device 1 provided with the four lighting units 100, 200, 300, and 400.

The respective components illustrated in FIGS. 1 and 2 are now more specifically explained. In the following description, the structure of the lighting unit 100 is chiefly discussed as a typical unit of the lighting units 100, 200, 300, and 400 having the same structure. Similarly, the structure of the fixing frame 10 is chiefly discussed as a typical frame of the fixing frames 10 and 20 having the same structure.

As illustrated in FIG. 2, the lighting unit 100 has a housing case 190. The housing case 190, which is made of metal having high heat conductivity, houses a transparent bottom cover 180, a board on which light emitting elements such as LEDs (described later) are mounted, and others.

As illustrated in FIGS. 1 and 2, the lighting unit 100 has a plurality of the heat radiation fins 112 standing above the housing case 190. The heat radiation fins 112 dissipate heat generated from the light emitting elements housed within the housing case 190 to the outside. In some of the figures referred to in the following description, only a part of the heat radiation fins are given the reference number “112”. However, all the flat components standing above the housing case 190 correspond to the heat radiation fins 112.

The fixing frame 10 fixes the lighting units 100 and 200, and the fixing frame 20 fixes the lighting units 300 and 400. The fixing frames 10 and 20 are made of metal, for example. The fixing frame 10 and the fixing frame 20 are secured to each other via spacers 31 through 33. The details of the mechanism for securing the fixing frames 10 and 20 will be explained later.

As illustrated in FIG. 1, an attachment member 14, a terminal stand 41, and power source devices 42a and 42b are equipped on the fixing frame 10. The attachment member 14 is made of metal, for example, and attached to a ceiling or the like. The terminal stand 41 relays power supply from a not-shown commercial alternating current power source to the power source devices 42a and 42b. The power source devices 42a and 42b supply the power relayed from the terminal stand 41 to boards mounted within the lighting units 100 and 200 via not-shown power source lines. Similarly, an attachment member 24, a terminal stand 51, and power source devices 52a and 52b are equipped on the fixing frame 20. The lighting device 1 is attached to a ceiling or the like by connection between the ceiling and the attachment members 14 and 24.

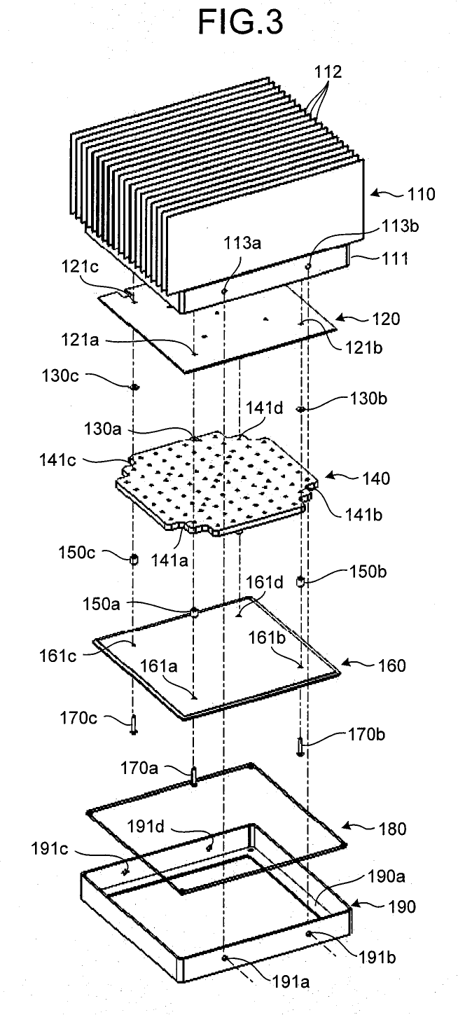

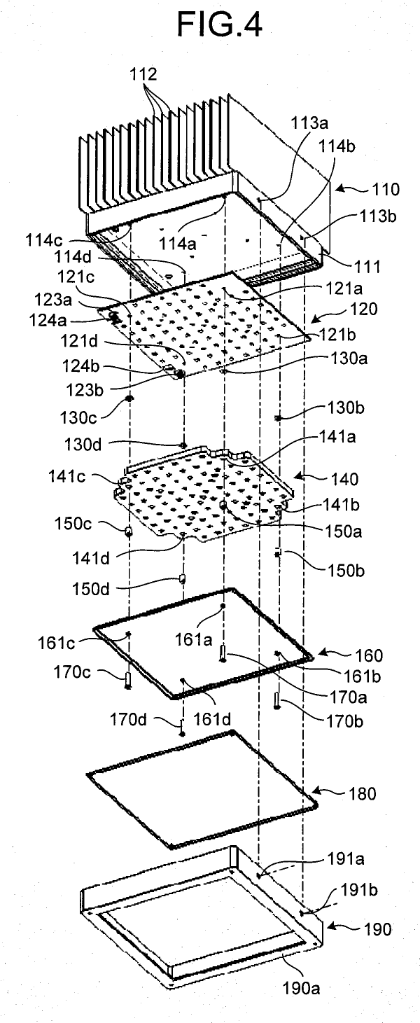

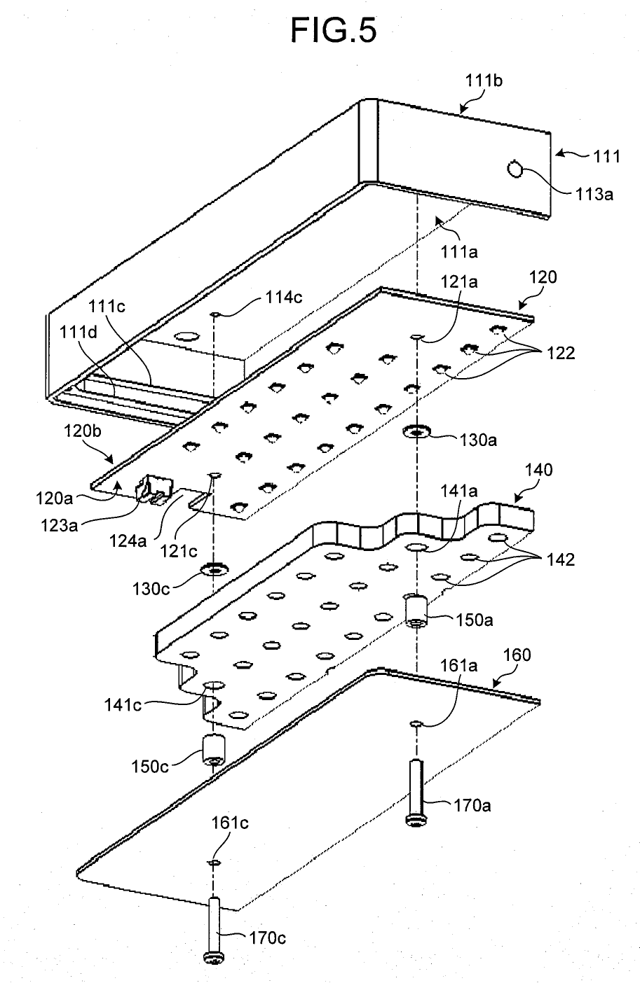

An example of a disassembled condition of the lighting unit 100 according to the first embodiment is now explained. FIGS. 3 through 5 are perspective views illustrating an example of a disassembled condition of the lighting unit 100 in the first embodiment. FIG. 3 shows an example of the lighting unit 100 as diagonally viewed from above. FIG. 4 shows an example of the lighting unit 100 as diagonally viewed from below. FIG. 5 illustrates an enlarged part of the lighting unit 100 shown in FIG. 4.

As illustrated in FIGS. 3 and 4, the lighting unit 100 in this embodiment includes a fin unit 110, the board 120, washers 130a through 130d, an insulating plate (a reflector) 140, spacers 150a through 150d, an optical lens 160, fixing screws 170a through 170d, the bottom cover 180, and the housing case 190.

The fin unit 110, which is made of metal having high heat conductivity, has the fin base 111 and the heat radiation fins 112. The fin base 111, functioning as a support member on which the board 120 is disposed, has the first surface 111a in tight face contact with the board 120, and the second surface 111b as the opposite side of the first surface 111a as illustrated in FIG. 5. The second surface 111b is a surface on which the heat radiation fins 112 stand.

The lower end of the fin base 111 has a substantially rectangular opening where the board 120, the insulating plate 140, the optical lens 160, and the bottom cover 180 are housed, with the first surface 111a forming the bottom of the opening. As illustrated in FIG. 5, the opening of the fin base 111 has two steps of a first step 111c and a second step 111d such that the opening area increases step by step in the direction from the first surface 111a toward the lower end of the opening.

As illustrated in FIGS. 3 and 4, screw holes 113a and 113b, into which not-shown fixing screws are threaded for fixation between the housing case 190 and the like and the fin base 111, are formed in the side surface of the outer wall of the fin base 111. Similarly, though not shown in the figures, not-shown screw holes similar to the screw holes 113a and 113b are formed in the side surface of the fin base 111 on the side opposed to the side surface in which the screw holes 113a and 113b are formed. As illustrated in FIG. 4, screw holes 114a through 114d, into which the corresponding fixing screws 170a through 170d are threaded, are formed in the first surface 111a of the fin base 111.

The heat radiation fins 112 stand on the second surface 111b of the fin base 111 substantially in parallel with each other with a predetermined clearance left between each other. As noted above, the heat radiation fins 112 dissipate heat generated from the light emitting elements 122 mounted on the board 120 to the outside.

As illustrated in FIG. 5, the board 120 has a mounting surface 120a on which the light emitting elements 122 are mounted, and a contact surface 120b as the opposite side of the mounting surface 120a. The contact surface 120b is a surface brought into tight face contact with the first surface 111a of the fin base 111. As illustrated in FIG. 5, the plural light emitting elements 122 are mounted on the mounting surface 120a. In the respective figures referred to in the following description, a part of the light emitting elements are given the reference number “122”. However, all the semispherical components mounted on the mounting surface 120a of the board 120 correspond to the light emitting elements 122. The board 120 is sized smaller than the opening area formed by the first step 111c so as to allow face contact between the contact surface 120b and the first surface 111a of the fin base 111.

As illustrated in FIGS. 3 through 5, screw through holes 121a through 121d, through which the corresponding fixing screws 170a through 170d are inserted, are formed in the board 120. It is assumed that the board 120 in the first embodiment has SMD (surface mount device) structure where the plural light emitting elements 122 are mounted on the mounting surface 120a. However, instead of the SMD structure, the board 120 may have COB (chip on board) structure where the plural light emitting elements 122 are arranged and mounted on a part or the entire area of the mounting surface 120a in a fixed regular order such as a matrix form, a staggered form, and a radial form.

As illustrated in FIGS. 4 and 5, the board 120 has connectors 123a and 123b mounted on the mounting surface 120a, and notches 124a and 124b are formed in the board 120. The connectors 123a and 123b connect with one ends of the not-shown power source lines. The other ends of the power source lines pass through the notches 124a and 124b and connect with the power source devices 42a and 42b. This structure allows the board 120 to cause light emission from the light emitting elements 122 using the power supplied from the power source devices 42a and 42b.

During light emission, the light emitting elements 122 generate heat which possibly raises the temperatures of the light emitting elements 122. With extremely high temperatures of the light emitting elements 122, the performance of the light emission elements 122 may deteriorate. According to the lighting unit 100 in the first embodiment, the heat radiation fins 112 stand on the second surface 111b as the opposite side of the first surface 111a brought into close face contact with the board 120. In this case, in the lighting unit 100 according to the first embodiment, the heat generated from the light emitting elements 122 is conducted via the fin base 111 to the heat radiation fins 112 disposed on the opposite side of the light emitting elements 122. Therefore, the heat can be dissipated with high efficiency.

Each of the washers 130a through 130d is a flat washer inserted between the insulating plate 140 and the board 120, and a screw through hole, through which the corresponding one of the fixing screws 170a through 170d is inserted, is formed in the washers 130a through 130d.

The insulating plate 140, which is made of synthetic resin having light resistance, heat resistance, and electrical insulating characteristics, for example, controls distribution of light emitted from the light emitting elements 122 mounted on the board 120. More specifically, as illustrated in FIG. 5, as for the insulating plate 140, adjustors 142 which are through holes are formed at positions opposed to the light emitting elements 122. The hole shapes of the adjustors 142 control the distribution of the light emitted from the light emitting elements 122. In the respective figures to be referred to in the following description, only a part of the adjustors are given the reference number “142”. However, all the holes formed in the insulating plate 140 at positions opposed to the light emitting elements 122 correspond to the adjustors 142.

As illustrated in FIGS. 3 through 5, screw through holes 141a through 141d, through which the fixing screws 170a through 170d are inserted, are formed in the insulating plate 140. The insulating plate 140 is sized smaller than the opening area formed by the first step 111c of the fin base 111 so as to be mounted on the mounting surface 120a of the board 120.

The spacers 150a through 150d are positioning members capable of maintaining the insulating plate 140 and the optical lens 160 in such positions as to be away from each other with a predetermined clearance left therebetween. In the spacers 150a through 150d, screw through holes, through which the fixing screws 170a through 170d are inserted, are formed.

The optical lens 160 diverges or converges the light having the distribution direction adjusted by the adjustors 142 of the insulating plate 140. In the optical lens 160, screw through holes 161a through 161d, through which the fixing screws 170a through 170d are inserted for fixation between the optical lens 160 and the fin base 111, are formed. The optical lens 160 according to the first embodiment is sized larger than the opening area formed by the first step 111c, and smaller than the opening area formed by the second step 111d, so as to be mounted on the first step 111c of the fin base 111. The optical lens 160 in the first embodiment includes Fresnel lenses and fly-eye lenses, the details of which will be described later.

The fixing screws 170a through 170d, which are made of metal, for example, fix the optical lens 160, the insulating plate 140, and the board 120 to the fin base 111. For example, the fixing screw 170a is inserted through the screw through hole 161a of the optical lens 160, the spacer 150a, the screw through hole 141a of the insulating plate 140, the washer 130a, and the screw through hole 121a of the board 120 in this order to be threaded into the screw hole 114a formed in the first surface 111a of the fin base 111. Similarly, the fixing screws 170b, 170c, and 170d are threaded into the screw holes 114b, 114c, and 114d of the fin base 111, respectively.

The bottom cover 180 is a transparent flat plate made of polycarbonate, acrylic resin, or other materials, for example. The bottom cover 180 is sized larger than the opening area formed by the second step 111d and smaller than the opening area formed by the lower edge of the fin base 111 so as to be mounted on the second step 111d of the fin base 111. The bottom cover 180 has the function of reducing glare of the light so intense that direct view of the light emission surface from the outside is difficult, and further the function of preventing contact between a human body and the interior of the housing case 190 from the outside.

The housing case 190 is made of synthetic resin such as ABS resin, or metal such as aluminum die casting, and is opened to both above and below substantially in a rectangular shape. The lower end of the opening is provided with a projection 190a projecting from the edge of the lower end of the opening toward the inside. The housing case 190 having this structure houses the fin base 111 to which the board 120, the insulating plate 140, and the optical lens 160 are fixed, and the bottom cover 180. Screw through holes 191a through 191d, through which not-shown screws are inserted for fixation between the housing case 190 and the fixing frame 10, are formed in the housing case 190.

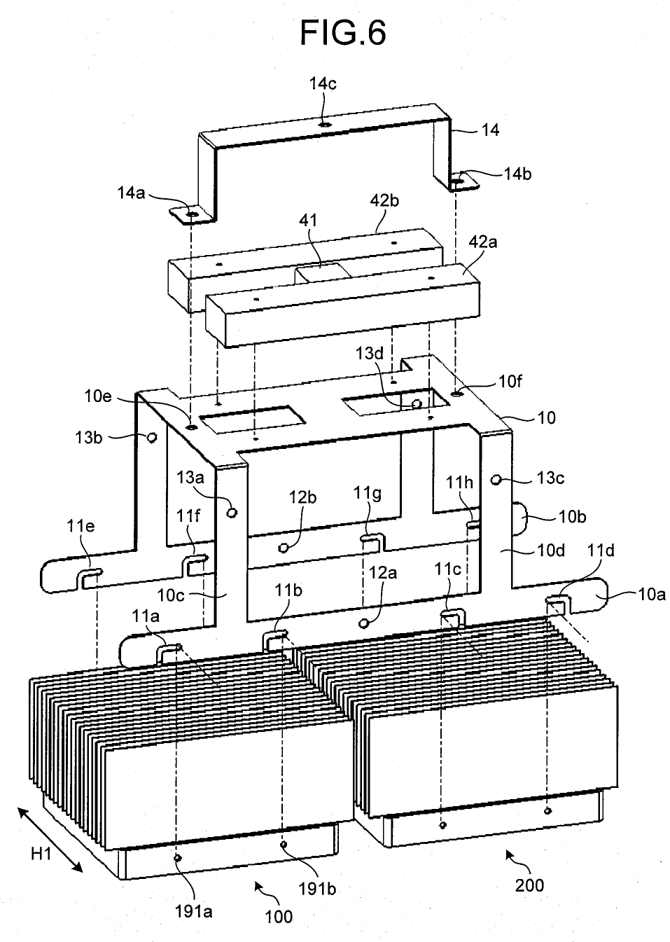

An example of a disassembled condition of the lighting device 1 according to this embodiment is now explained. FIG. 6 is a perspective view illustrating an example of disassembled condition of the lighting device 1 according to the first embodiment. FIG. 6 shows the lighting units 100 and 200 fixed to the fixing frame 10 as an example.

As illustrated in FIG. 6, the fixing frame 10 includes a pair of lower fixing portions 10a and 10b, and a pair of bridging portions 10c and 10d. The lower fixing portions 10a and 10b are flat components whose lengths in the lateral direction are substantially equivalent to the length of the housing case 190 in the height direction. The lower fixing portions 10a and 10b are positioned opposed to each other with a space left therebetween, which space is substantially equivalent to the length of the heat radiation fins 112 in an arrangement direction H1. The bridging portions 10c and 10d extend longer than the length of the heat radiation fins 112 in the height direction from the upper ends of the lower fixing portions 10a and 10b, and bridge the space between the lower fixing portions 10a and 10b.

Notches 11a through 11d are formed in the lower fixing portion 10a of the fixing frame 10. Similarly, notches 11e through 11h are formed in the lower fixing portion 10b. A not-shown fixing screw is inserted through the notch 11a and the screw through hole 191a of the housing case 190 and threaded into the screw hole 113a of the fin base 111. Similarly, a not-shown fixing screw is inserted through the notch 11b and the screw through hole 191b and threaded into the screw hole 113b. The lower fixing portion 10b has a similar structure. More specifically, not-shown fixing screws are threaded via the notches 11e and 11f into the screw holes formed in the side surface of the fin base 111. This structure allows fixation between the lighting unit 100 and the fixing frame 10. Similarly, the lighting unit 200 is secured to the fixing frame 10 by fixing screws tightened via the notches 11c, 11d, 11g, and 11h.

As illustrated in FIG. 6, the terminal stand 41, and the power source devices 42a and 42b are fixed to the upper surface of the fixing frame 10. The attachment member 14 is fixed to the fixing frame 10 by not-shown fixing screws inserted through screw through holes 14a and 14b formed in the attachment member 14 and threaded into screw holes 10e and 10f formed in the upper surface of the fixing frame 10.

The mechanism for junction between the fixing frame 10 and the fixing frame 20 is now explained. As illustrated in FIG. 6, a pair of screw through holes 12a and 12b is formed at the position facing each other of the lower fixing portions 10a and 10b of the fixing frame 10. Moreover, a pair of screw through holes 13a and 13b is formed at the position, which is extended portions of the bridging portion 10c from the lower fixing portions 10a and 10b in the upward direction, facing each other of the bridging portion 10c. Similarly, a pair of screw through holes 13c and 13d is formed at the position facing each other of the bridging portion 10d. As illustrated in FIGS. 1 and 2, the fixing frame 20 has screw through holes in the lower fixing portions and the bridging portions similarly to the fixing frame 10. For example, as illustrated in FIG. 1, screw through holes 23a and 23c, corresponding to the screw through holes 13a and 13c of the fixing frame 10, are formed in the fixing frame 20. Moreover, as illustrated in FIG. 2, a screw through hole 22a, corresponding to the screw through hole 12a of the fixing frame 10, is formed in the fixing frame 20, for example.

According to this structure, as illustrated in FIG. 1, the spacer 31 is inserted between the screw through hole 13b of the fixing frame 10 and the screw through hole 23a of the fixing frame 20. A not-shown fixing screw is inserted through the screw through hole 13b and threaded into the spacer 31, and a not-shown fixing screw is inserted through the screw through hole 23a and threaded into the spacer 31. Similarly, the spacer 32 is inserted between the screw through hole 13d of the fixing frame 10 and the screw through hole 23c of the fixing frame 20. A not-shown fixing screw is inserted through the screw through hole 13d and threaded into the spacer 32, and a not-shown fixing screw is inserted through the screw through hole 23c and threaded into the spacer 32. Furthermore, as illustrated in FIG. 2, the spacer 33 is inserted between the screw through hole 12b of the fixing frame 10 and the screw through hole 22a of the fixing frame 20. A not-shown fixing screw is inserted through the screw through hole 12b and threaded into the spacer 33, and a not-shown fixing screw is inserted through the screw through hole 22a and threaded into the spacer 33.

By junction between the fixing frame 10 and the fixing frame 20 in this manner, the large-scale lighting device 1 including the lighting units 100, 200, 300, and 400 is produced.

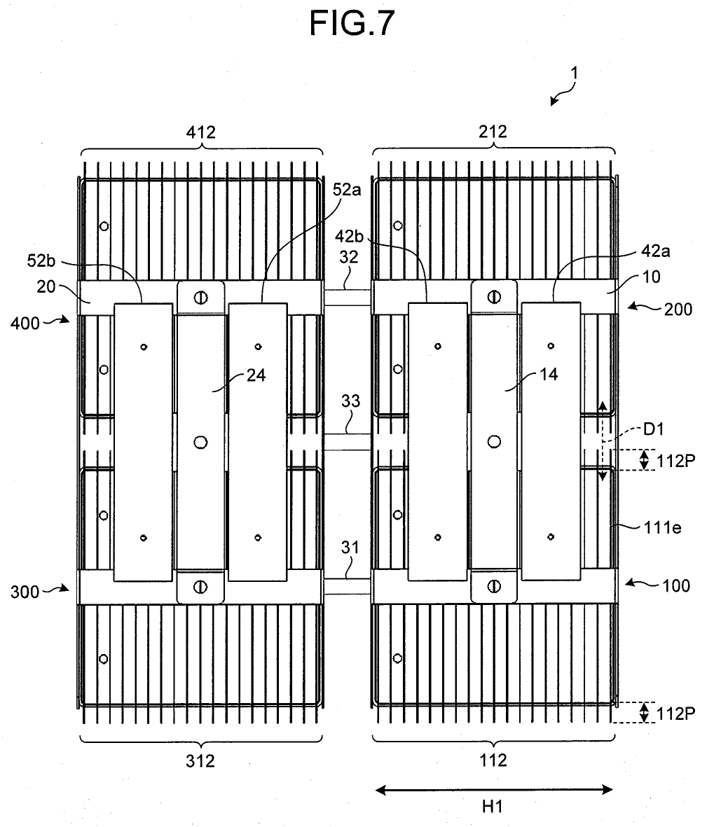

An example of the external appearance of the lighting device 1 in the first embodiment as viewed from above is now explained. FIG. 7 is a top view of the lighting device 1 according to the first embodiment. As illustrated in FIG. 7, each of the plural heat radiation fins 112 of the lighting unit 100 has the projection 112P projecting toward the outside from the edge of the second surface 111b of the fin base 111 (or the housing case 190). More specifically, each of the plural heat radiation fins 112 stands on the second surface 111b such that each side of the heat radiation fins 112 longer than a predetermined side 111e as the edge of the second surface 111b extends substantially parallel with the side 111e. Similarly, each of heat radiation fins 212 of the lighting unit 200, each of heat radiation fins 312 of the lighting unit 300, and each of heat radiation fins 412 of the lighting unit 400 have similar projections as those of the heat radiation fins 112.

As can be understood, each of the heat radiation fins 112, 212, 312, and 412 according to the first embodiment has a flat shape provided with the projection producing a large area. Thus, the contact area between the respective fins and the atmospheric air increases, wherefore the heat dissipation efficiency improves.

Moreover, as illustrated in FIG. 7, the lighting units 100, 200, 300, and 400 are fixed by the fixing frames 10 and 20 in such a condition that the heat radiation fins of each of the lighting units 100, 200, 300, and 400 do not contact the heat radiation fins of the other lighting units. More specifically, as illustrated in FIG. 7, the heat radiation fins 112 do not contact the heat radiation fins 212, and the heat radiation fins 312 do not contact the heat radiation fins 412. In other words, the notches 11a through 11h are formed in the fixing frame 10 for fixing the lighting units 100 and 200 in such a condition as to avoid contact between the heat radiation fins 112 and the heat radiation fins 212. Similarly, the notches are formed in the fixing frame 20 for fixing the lighting units 300 and 400 in such a condition as to avoid contact between the heat radiation fins 312 and the heat radiation fins 412.

According to the lighting device 1 in the first embodiment which includes the heat radiation fins 112, 212, 312, and 412 arranged in such a manner as to avoid contact between each other, no blockage is produced for the flow of air between the respective lighting units. Thus, the heat dissipation efficiency improves.

Furthermore, as illustrated in FIG. 7, the heat radiation fins 112 and 212 of the lighting units 100 and 200 are arranged in similar positions. In other words, the heat radiation fins 112 and 212 are located on the extension lines from each other. Similarly, the heat radiation fins 312 and 412 of the lighting units 300 and 400 are arranged in similar positions. In this case, the atmospheric air easily flows in a direction D1 indicated in FIG. 7 between the heat radiation fins 112 and 212, for example. Consequently, the heat dissipation effect of the heat radiation fins 112 and 212 improves without stay of high-temperature air.

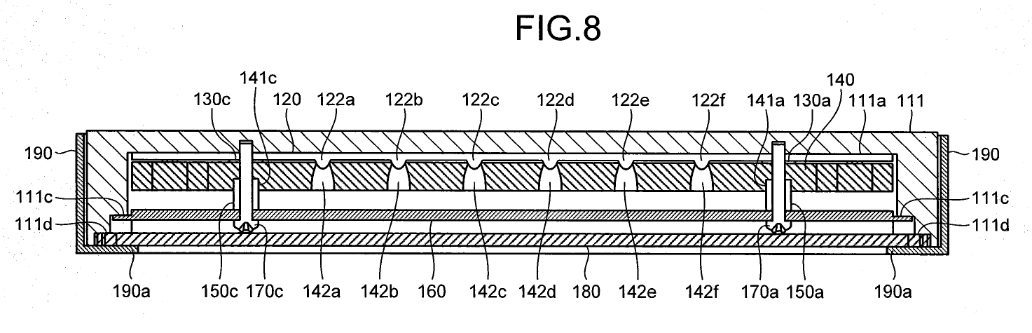

A cross section of the lighting unit 100 in the first embodiment is now explained. FIG. 8 illustrates the cross section taken along a line I-I in FIG. 1. As can be seen from FIG. 8, the board 120 is brought into tight face contact with the first surface 111a of the fin base 111. In the example shown in FIG. 8, lighting elements 122a through 122f are mounted on the board 120. The insulating plate 140 is further laminated with the washers 130a and 130c interposed between the insulating plate 140 and the board 120. The insulating plate 140 has adjustors 142a through 142f at positions opposed to the light emitting elements 122a through 122f. The adjustors 142a through 142f are through holes whose diameters gradually increase in the direction from the light emitting elements 122 toward the optical lens 160.

The optical lens 160 is placed on the first step 111c of the fin base 111 with the spacers 150a and 150c inserted between the optical lens 160 and the insulating plate 140. The fixing screw 170a is inserted through the optical lens 160, the spacer 150a, the insulating plate 140, the washer 130a, and the board 120 in this order to be threaded into the first surface 111a of the fin base 111. Similarly, the fixing screw 170c is inserted through the optical lens 160, the spacer 150c, the insulating plate 140, the washer 130c, and the board 120 in this order to be threaded into the first surface 111a of the fin base 111. By this fixation, the board 120, the insulating plate 140, and the optical lens 160 are attached to the fin base 111.

According to the example shown in FIG. 8, a part of the spacers 150a and 150c are embedded in the screw through holes 141a and 141c of the insulating plate 140. Thus, the screw through hole 141a (and other) of the insulating plate 140 is so designed as to have a larger diameter than the outside diameter of the spacer 150a in the range between the end of the insulating plate 140 on the insertion side of the spacer 150a and the middle of the insulating plate 140 such that the spacer 150a can be embedded in the screw through hole 141a.

The bottom cover 180 is held between the second step 111d of the fin base 111 and the projection 190a of the housing case 190. Though not shown in the figures, the bottom cover 180 is fixed to the fin base 111 by a fixing screw inserted through the projection 190a and the bottom cover 180 in this order and threaded into the second step 111d.

According to this structure, the spacers 150a and 150c are inserted between the insulating plate 140 and the optical lens 160 so that the insulating plate 140 and the optical lens 160 can be positioned away from each other by a predetermined distance. In this case, the optical lens 160 of the lighting unit 100 in the first embodiment is not easily affected by the heat generated from the board 120. For divergence or convergence of light in a desired condition, the optical lens 160 needs to be disposed away from the light emitting elements 122 by a predetermined distance. In the case of the lighting unit 100 in the first embodiment, the distance between the insulating plate 140 and the optical lens 160 is determined by the spacers 150a and 150c, so that the optical lens 160 can diverge or converge light in a desired condition.

According to the example shown in FIG. 8 (and FIG. 5), the first step 111c and the second step 111d are formed in the fin base 111. However, these steps 111c and 111d are not mechanisms for positioning the optical lens 160 and the bottom cover 180, but only function as portions for temporarily positioning these components 160 and 180. The positional relationship between the insulating plate 140 and the optical lens 160 is determined only by the spacers 150a through 150d. Thus, the fin base 111 is not necessarily required to have such a stepped configuration produced by the first step 111c and the second step 111d.

According to the first embodiment, the spacers 150a through 150d determine the positions of the insulating plate 140 and the optical lens 160 such that the two components 140 and 160 are located away from each other by a predetermined distance. However, a positioning member which has a function similar to that of the spacers 150a through 150d may be formed integrally with the insulating plate 140 or with the optical lens 160. For example, the insulating plate 140 may have a convex corresponding to the positioning member extended from the lower surface of the insulating plate 140 toward the optical lens 160. Similarly, the optical lens 160 may have a convex corresponding to the positioning member extended from the upper surface of the optical lens 160 toward the insulating plate 140.

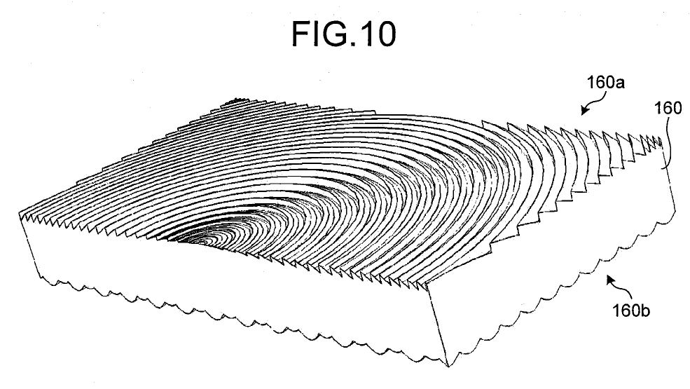

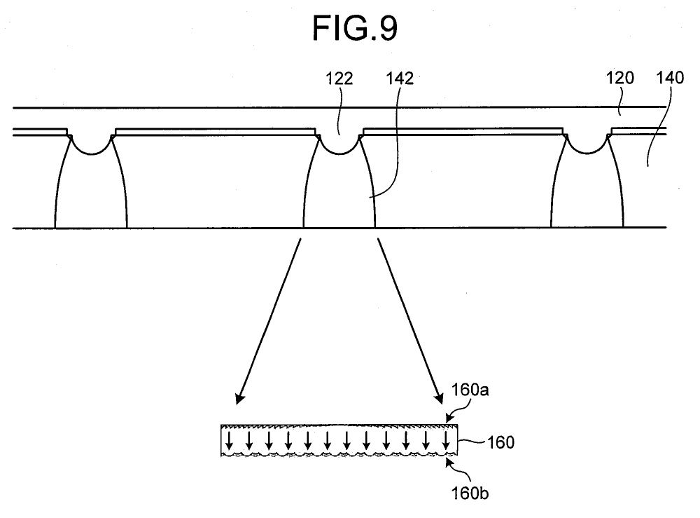

The optical lens 160 in the first embodiment is now explained. FIG. 9 schematically illustrates an enlarged cross section of the optical lens 160 according to the first embodiment. FIG. 10 illustrates an example of the external appearance of an enlarged cross section of the optical lens 160 according to the first embodiment. As illustrated in FIGS. 9 and 10, the optical lens 160 in the first embodiment has a Fresnel lens 160a at a position opposed to each of the light emitting elements 122 (adjustors 142), and a fly-eye lens 160b on the opposite side of the Fresnel lens 160a.

Each of the Fresnel lens 160a refracts light received from the corresponding light emitting element 122 after control of light distribution by the function of the adjustor 142 to convert the light into collimated light without decreasing the total amount of the light. More specifically, the Fresnel lens 160a refracts the light applied thereto from the adjustor 142 in a direction substantially perpendicular to the fly-eye lens 160b without attenuating the light. The fly-eye lens 160b diffuses the light refracted by the Fresnel lens 160a without attenuation to supply the light toward a not-shown area on the bottom cover 180 side.

The Fresnel lens 160a and the fly-eye lens 160b of the optical lens 160 shown at a position opposed to the one light emitting element 122 (adjustor 142) in FIG. 9 and illustrated in FIG. 10 as the external appearance of the optical lens 160 are provided opposed to all the light emitting elements 122 (adjustors 142).

As noted above, the optical lens 160 according to the first embodiment refracts the light emitted from the light emitting elements 122 by the function of the Fresnel lens 160a to convert the light into collimated light, thereby illuminating a room or the like without decreasing the total amount of the light. Moreover, the optical lens 160 diffuses the light by the function of the fly-eye lens 160b, thereby reducing glare of the light so intense that direct view from the outside is difficult. In this case, the optical lens 160 allows illumination of the room or the like without decreasing the total amount of the light emitted from the light emitting elements 122, and with reduction of the glare of the light. Accordingly, efficient use of the light emitted from the light emitting elements 122 for illumination of the room or the like can be realized.

As described above, in the lighting unit 100 according to the first embodiment, the contact surface 120b of the board 120 is disposed on the first surface 111a of the fin base 111, and the plural heat radiation fins 112 stand on the second surface 111b as the opposite side of the first surface 111a.

According to the lighting unit 100 in the first embodiment, therefore, the heat generated from the light emitting elements 122 mounted on the board 120 is efficiently conducted via the fin base 111 to the heat radiation fins 112 located on the opposite side of the light emitting elements 122. Thus, heat dissipation can be efficiently achieved.

Particularly, when the light emitting elements 122 are high-output elements such as LEDs, the temperatures of the light emitting elements 122 easily increase. Under this condition, there is a possibility that the heat generated from the light emitting elements 122 is not efficiently conducted to the heat radiation fins when the heat radiation fins stand on the housing main body or the insulating plate made of aluminum die casting or the like. For avoiding this problem, the configuration of the respective heat radiation fins is enlarged so that a sufficient heat dissipation effect can be produced. In this case, the size and weight of the lighting unit 100 increase. On the other hand, the lighting unit 100 in the first embodiment capable of efficiently dissipating the heat does not require scale magnification of the heat radiation fins 112 even when the high-output light emitting elements 122 are employed. Accordingly, reduction of the size and weight of the lighting unit 100 (lighting device 1) can be realized.

For expansion of the configuration of the heat radiation fins, increase in the height of the heat radiation fins is needed. In this case, unnecessary areas are required so as to increase the thickness of the roots of the heat radiation fins for draft angle cutting. However, according to the lighting unit 100 in the first embodiment, the heat radiation fins 112 stand on the fin base 111 without requiring enlargement of the scale of the heat radiation fins 112. Thus, no additional area for draft angle cutting is needed. Based on this point, reduction of the scale and weight of the lighting unit 100 (lighting device 1) is similarly achieved according to the first embodiment.

According to the lighting unit 100 in the first embodiment, each of the plural heat radiation fins 112 has the projection 112P projecting from the edge of the second surface 111b of the fin base 111 toward the outside. Thus, the heat dissipation effect improves.

According to the lighting unit 100 in the first embodiment, the spacers 150a through 150d as positioning members determine the position of the insulating plate 140 for controlling the reflection direction of the light emitted from the light emitting elements 122, and the position of the optical lens 160 for diverging or converging the light reflected by the insulating plate 140, such that the two components 140 and 160 can be located away from each other by the predetermined distance.

Therefore, the optical lens 160 of the lighting unit 100 in the first embodiment is not easily affected by the heat generated from the board 120, and allowed to diverge and converge the light in a desired condition.

According to the lighting device 1 in the first embodiment, the fixing frames 10 and 20 fix the respective lighting units 100, 200, 300, and 400 without contact between the heat radiation fins of each of the lighting units 100, 200, 300, and 400 and the heat radiation fins of the other lighting units. Therefore, the heat dissipation effect of the lighting device 1 in the first embodiment improves without blockage of the flow of air between the respective lighting units.

### Second Embodiment

The lighting device 1, the lighting unit 100 and others according to the first embodiment may be modified in various ways. An example of the lighting device 1, the lighting units and others according to a second embodiment as modifications of the corresponding parts in the first embodiment is hereinafter described. In the following explanation, the lighting unit 100 is chiefly discussed similarly to the first embodiment. However, the mechanisms and the like discussed herein are applicable to the lighting units 200, 300, and 400 as well.

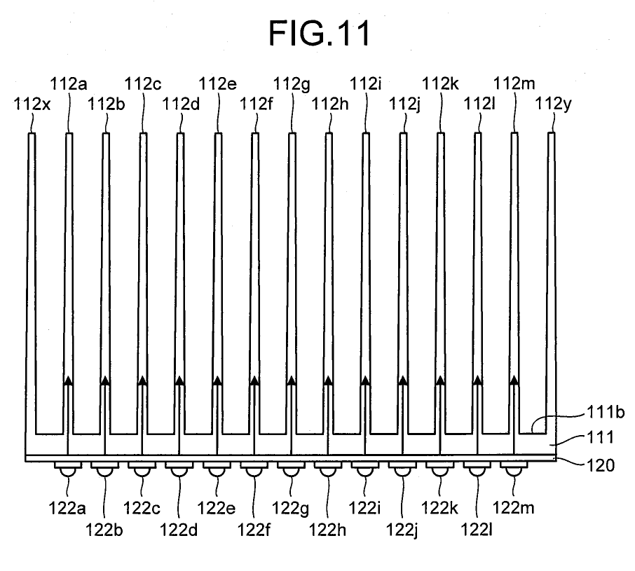

According to the first embodiment, the heat radiation fins 112 stand on the second surface 111b of the fin base 111. However, the standing positions of the heat radiation fins 112 on the second surface 111b may be determined in correspondence with the opposite positions of the light emitting elements 122 mounted on the board 120. This structure is now explained with reference to FIG. 11. FIG. 11 schematically illustrates an enlarged cross section of the heat radiation fins 112 according to the second embodiment.

In the example shown in FIG. 11, heat radiation fins 112a through 112m stand on the second surface 111b of the fin base 111 at the positions corresponding to the opposite side of light emitting elements 122a through 122m mounted on the board 120. When the respective heat radiation fins 112 are disposed just above the light emitting elements 122 as in the lighting unit 100 in this example, the heat generated from the light emitting elements 122 can be efficiently conducted to the heat radiation fins 112 as indicated by arrows in FIG. 11. Thus, the heat dissipation effect improves.

The standing positions of the heat radiation fins 112 are not limited to the positions shown in FIG. 11 but may be such positions not opposed to the light emitting elements 122. For example, heat radiation fins 112x and 112y may stand at positions not opposed to the light emitting elements 122 as illustrated in FIG. 11. Also, though not shown in FIG. 11, a heat radiation fin may be positioned between the heat radiation fin 112a and the heat radiation fin 112b in the example shown in FIG. 11.

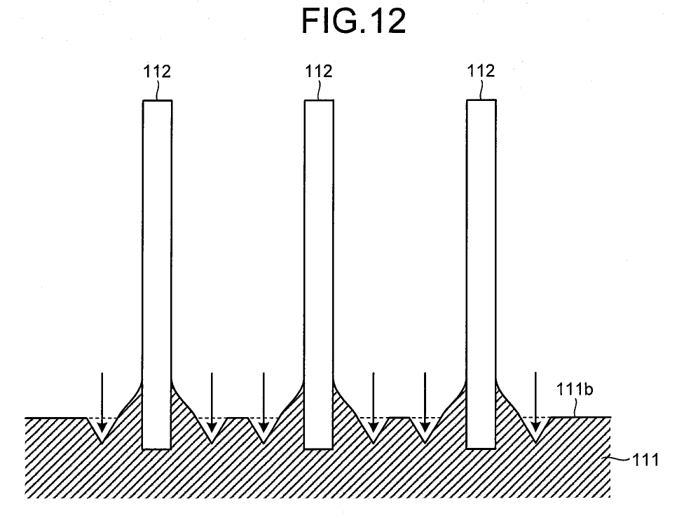

The standing mechanism of the heat radiation fins 112 is now explained. FIG. 12 schematically illustrates an enlarged cross section of the heat radiation fins 112 according to the second embodiment. As illustrated in FIG. 12, one end of each of the heat radiation fins 112 is embedded in the second surface 111b of the fin base 111. The heat radiation fins 112 in this condition are pressed by using a stick for calking or the like in the direction indicated by arrows in FIG. 12 under contact bonding with the second surface 111b so as to be embedded in the fin base 111, for example. More specifically, raised areas from the second surface 111b are produced by the shift of the regions of the fin base 111 pressed by the stick or the like to other regions as illustrated in FIG. 12, so that one ends of the respective heat radiation fins 112 can be embedded in the raised areas of the fin base 111.

When the one ends of the heat radiation fins 112 are embedded in the fin base 111, the contact area between the heat radiation fins 112 and the fin base 111 increases. In this case, the heat generated from the light emitting elements 122 of the lighting unit 100 can be efficiently conducted from the fin base 111 to the respective heat radiation fins 112, wherefore the heat dissipation effect improves.

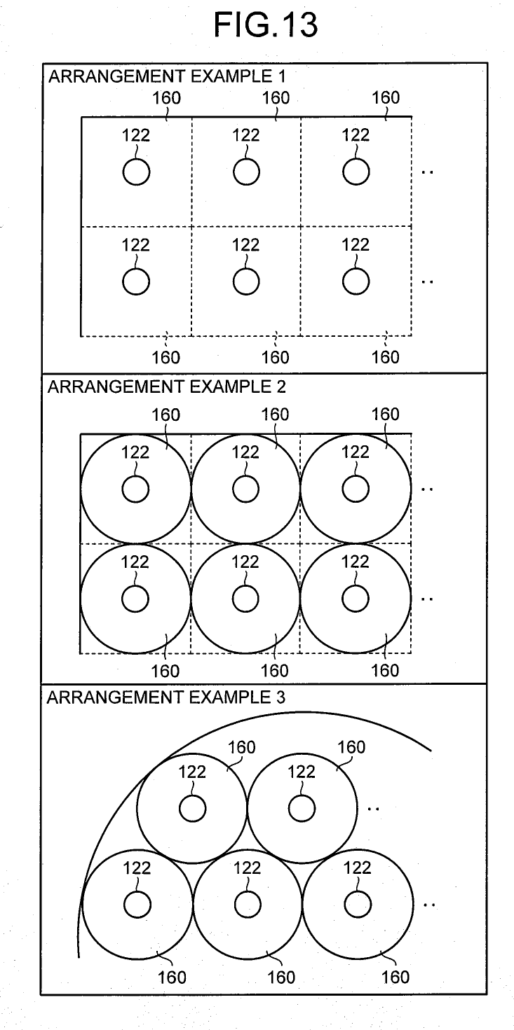

The arrangement pattern of the optical lens 160 according to the first embodiment shown in FIGS. 9 and 10 may be determined in various ways. These pattern variations are now explained with reference to FIG. 13. FIG. 13 illustrates the arrangement patterns of the optical lens 160 according to the second embodiment. FIG. 13 shows only the light emitting elements 122 and the optical lens 160 as viewed from above (in the direction from the light emitting elements 122 to the optical lens 160).

According to an example shown in <ARRANGEMENT EXAMPLE 1> in FIG. 13, rectangular pieces of the optical lens 160 shown in FIG. 10 are disposed at positions opposed to the respective light emitting elements 122. Alternatively, circular pieces of the optical lens 160 may be arranged at positions opposed to the respective light emitting elements 122 as in an example shown in <ARRANGEMENT EXAMPLE 2> in FIG. 13. When the board 120 and the like are circular, such a structure is allowed where the light emitting elements 122 are mounted on the circular board 120 in a grid pattern as illustrated in an example shown in <ARRANGEMENT EXAMPLE 3> in FIG. 13. In this case, circular pieces of the optical lens 160 may be disposed at positions opposed to the respective light emitting elements 122 as in the example shown in <ARRANGEMENT EXAMPLE 3> in FIG. 13.

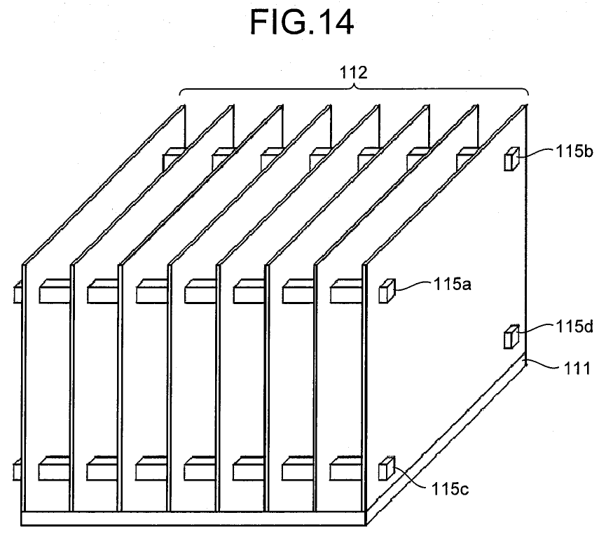

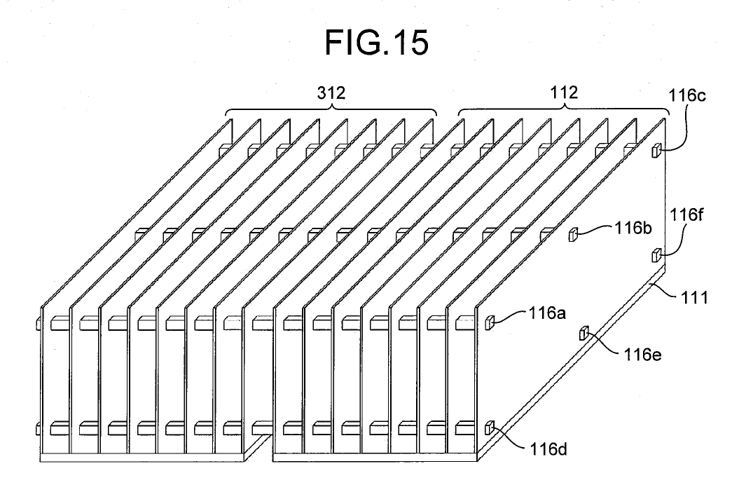

It can be understood that the heat radiation fins 112 employed in the first embodiment have flat shapes and therefore are easily bended or deformed into other shapes. For preventing this problem, the lighting unit 100 may have bar-shaped components penetrating the respective surfaces of the plural heat radiation fins. This structure is now explained with reference to FIGS. 14 and 15. FIGS. 14 and 15 illustrate examples of the bar-shaped components according to the second embodiment.

As illustrated in FIG. 14, the bar-shaped components 115a through 115d, which are made of metal having high heat conductivity or the like, penetrate the surfaces of the plural heat radiation fins 112 standing on the fin base 111. The bar-shaped components 115a through 115d provided in this manner combine the plural heat radiation fins 112 into one body. In this case, the plural heat radiation fins 112 can be reinforced for each for avoiding deformation. According to the example shown in FIG. 14, the bar-shaped components 115a through 115d penetrate the peripheries (four corners) of the surfaces of the plural heat radiation fins 112 so as not to block the flow of air.

According to an example shown in FIG. 15, penetrating-bar-shaped components 116a through 116f penetrate the surfaces of both the heat radiation fins 112 of the lighting unit 100 and the heat radiation fins 312 of the lighting unit 300. According to this structure, the penetrating-bar-shaped components 116a through 116f cross and combine the plural heat radiation fins of the different lighting units into one body for reinforcement. Thus, deformation of the plural heat radiation fins can be further prevented.

While FIGS. 14 and 15 show the heat radiation fins 112 and 312 not having the projections 112P projecting from the edges of both ends of the second surface 111b toward the outside, the heat radiation fins 112 and 312 shown in FIGS. 14 and 15 may have the projections 112P.

The lighting device 1 installed on a high ceiling as in the above examples is applicable to a surface-mounting type lighting device attached to places other than a high ceiling.

The respective components fixed to the lighting device 1 via the fixing screws as in the above examples may be fixed via other fixing members such as pins instead of the fixing screws.

The configurations and materials of the respective parts in the foregoing embodiments are not limited to those described and depicted therein. For example, the fin unit 110, the board 120, the insulating plate 140, the optical lens 160, the bottom cover 180, and the housing case 190 may be circular components instead of rectangular components.

Accordingly, improvement over the heat dissipation effect can be achieved according to the respective embodiments.

Although certain embodiments of the invention have been described in the foregoing description, it is intended that the scope of the invention is not limited to the embodiments disclosed as only examples but is susceptible to numerous modifications and variations. Therefore, various eliminations, replacements, and changes may be made without departing from the scope and spirit of the invention. The respective embodiments and modifications included in the scope and spirit of the invention are also included in the scope of the invention claimed in the appended claims and the equivalents thereof.

What is claimed is:

1. A lighting unit, comprising:
a board which includes amounting surface on which a light emitting element is mounted;
an insulating plate disposed on the mounting surface of the board and having holes through which light emitted from the light emitting element is passed;
an optical lens for directing the light that is passed through the holes of the insulating plate; and
a positioning member disposed in the lighting unit to separate the insulating plate from the optical lens by a predetermined distance.

2. The unit according to claim 1, wherein the positioning member is disposed between the insulating plate and the optical lens.

3. The unit according to claim 2, wherein the insulating plate is formed integrally with the positioning member.

4. The unit according to claim 2, wherein the insulating plate has a hole on a surface facing the optical lens into which the positioning member is inserted.

5. The unit according to claim 1, wherein the optical lens has a planar surface facing the insulating plate that is substantially parallel to a surface of the insulating plate facing the optical lens.

6. The unit according to claim 1, further comprising:
a support member having an interior surface on which the board is disposed such that the interior surface and the board are in close contact; and
a plurality of heat radiation fins disposed on an exterior surface of the support member that is on an opposite side of the interior surface.

7. The unit according to claim 6, wherein the heat radiation fins have elongated flat sides that are substantially parallel to each other and are physically separated from each other.

8. The unit according to claim 7, wherein opposing ends of each of the plural heat radiation fins extend past corresponding ends of the exterior surface.

9. The unit according to claim 6, wherein one end of each of the heat radiation fins is embedded in the exterior surface and extends in a direction away from the exterior surface.

10. The unit according to claim 6, further comprising a bar-shaped component made of metal and penetrating the respective surfaces of the plural heat radiation fins.

11. The unit according to claim 10, wherein the bar-shaped component penetrates outer peripheries of the respective surfaces of the plural heat radiation fins.

12. The unit according to claim 6, wherein plural light emitting elements are mounted on the board and the plural heat radiation fins are disposed on the exterior surface to be directly opposite to positions of the light emitting elements.

13. The unit according to claim 6, wherein the support member is made of heat conductive metal.

14. A lighting device, comprising:
a plurality of the lighting units, each including a board on which a light emitting element is mounted, an insulating plate having holes through which light emitted from the light emitting element is passed, an optical lens for directing the light that is passed through the holes of the insulating plate, a positioning member disposed in the lighting unit to separate the insulating plate from the optical lens by a predetermined distance, a support member having an interior surface on which the board is disposed such that the interior surface and the board are in close contact, and a plurality of heat radiation fins disposed on an exterior surface of the support member that is on an opposite side of the interior surface; and
a fixing frame which fixes the plural lighting units such that the heat radiation fins of the plural lighting units do not contact each other.

15. The device according to claim 14, further comprising a penetrating-bar-shaped component made of metal and penetrating the respective surfaces of the plural heat radiation fins of the plural lighting units.

16. The device according to claim 14, wherein the heat radiation fins of each of the lighting units have elongated flat sides that are substantially parallel to each other and are physically separated from each other, and opposing ends of each of the plural heat radiation fins extend past ends of the exterior surface on which they are disposed.

17. The device according to claim 16, wherein the heat radiation fins of all of the lighting units are arranged in parallel.

18. A method of assembling a lighting unit having a board on which a plurality of light emitting elements are mounted, said method comprising:
pressing the board against an interior surface of a support member such that the interior surface and the board are in close contact;
positioning an insulating plate having holes such that the holes are aligned with the light emitting elements;
mounting an optical lens to be a predetermined distance separated from the insulating plate by placing a positioning member in between the insulating plate and the optical lens.

19. The method of claim 18, further comprising:
affixing a plurality of heat radiation fins on an exterior surface of the support member that is on an opposite side of the interior surface.

20. The method of claim 19, wherein the heat radiation fins are affixed on the exterior surface of the support member to be opposite positions of the light emitting elements mounted on the board.
